(19) United States
(12) Patent Application Publication
(10) Pub. No.: US 2006/0085675 A1
(43) Pub. Date: Apr. 20, 2006

(54) One-touch backup system

(76) Inventors: Andrew Popell, San Francisco, CA (US); Jonathan Betts-LaCroix, Chatsworth, CA (US)

Correspondence Address: ROBERT PLOTKIN, PC, 91 MAIN STREET, SUITE 204, CONCORD, MA, 01742-2527, US

(21) Appl. No.: 11/247,078

(22) Filed: Oct. 11, 2005

Related U.S. Application Data
(60) Provisional application No. 60/617,999, filed on Oct. 12, 2004.

(51) Int. Cl. G06F 11/00; G06F 12/16

(52) U.S. Cl. 714/6; 711/162

(57) ABSTRACT

Techniques are disclosed for backing up or restoring the state of a mobile computing device in response to a single action performed by a user. A user may, for example, insert the mobile computing device into a cradle and press a “backup” button on the cradle or device, in response to which the state of the mobile computing device may be backed up to persistent storage media, such as a hard disk, in the cradle. Similarly, a user may insert the mobile computing device into the cradle and press a “restore” button on the cradle or device, in response to which the saved state of the mobile computing device may be restored. State that may be backed up to the cradle includes the contents of persistent media, RAM, and CMOS in the mobile storage device.

### CROSS REFERENCE TO RELATED APPLICATIONS

This application claims priority from U.S. Provisional Patent Application Ser. No. 60/617,999 filed on Oct. 12, 2004, entitled “One-Touch Backup System,” which is hereby incorporated by reference.

### BACKGROUND

1. Field of the Invention

The present invention relates to storage systems for personal computing devices and, more particularly, to backup systems for personal computing devices.

2. Related Art

It is critical that computer data be backed up regularly and reliably in the event that the original data become corrupted, erased, or lost. The importance of regular and reliable backup has been gaining attention as individuals and enterprises store an increasingly large amount of increasingly important data electronically. The crash of a single hard drive can have devastating consequences if the data previously stored on the hard drive were not backed up properly or recently.

It must also be possible to restore backup-up data quickly and reliably if a backup solution is to be complete and effective. For a restore operation to be successful, the original data must be accessible and means must be available for retrieving the lost data from the backup media.

Relatively effective backup solutions have been developed and implemented for desktop computers and workstations, particularly in cases where such computers are permanently connected to a network. Such computers may, for example, be individually equipped with high-capacity storage devices, such as tape backup drives, that may be scheduled to perform periodic (e.g., daily) backup operations automatically. Alternatively, such computers may equipped with software for automatically backing up data over a network to a backup server equipped with storage capacity sufficient to satisfy the backup needs of all computers on the network. Restoring data to such computers requires restoring the appropriate files from the tape on which it is stored or restoring files over the network from the backup server.

Even in the case of such systems, many factors tend to mitigate the effectiveness of backup and restore operations. For example, in some cases it is desirable to back up less than all of the data stored on a particular hard disk drive or associated with a particular user. It may, for example, be desirable to back up only critical data files to reduce the amount of resources devoted to backup operations. In such cases it is typically necessary for the user or system administrator to identify those files that should be backed up and to configure the backup system to back up only the identified files. In such cases it is possible that the user or system administrator will fail to identify critical files that need to be backed up, thereby decreasing the effectiveness of the backup system. Selecting the set of files to be backed up can be a difficult task, in part because it may not become apparent that particular files are critical until after they have been corrupted or lost.

More generally, even backup systems that are relatively automated typically require some degree of manual configuration and intervention. For example, backup tapes may need to be replaced and catalogued as they become full, and backup tapes containing particular data may need to be identified in order to perform a restore operation. Performing a backup or restore operation using the software interfaces provided by backup systems typically requires the user to perform a sequence of steps, such as selecting the data to be backed up or restored, selecting the storage media to use for the backup or restore operation, and selecting the time at which to perform the backup or restore operation. For these reasons, performing a backup or restore operation can be tedious and time-consuming.

Mobile computing devices, such as laptop computers, personal digital assistants (PDAs), and tablet computers, can be particularly difficult to back up and restore reliably and easily. For example, mobile computing devices often do not include high-capacity removable storage devices, such as tape backup drives, and often are not permanently connected to a high-bandwidth network. As a result, users often perform backups on their mobile computing devices less regularly than is desirable or not at all.

One way to back up a mobile computing device is to connect it to a computer (such as a backup server) equipped with backup software and a high-capacity storage device. Such a connection may be established using a direct connection or over a network. The mobile computing device's data may then be backed up by transferring it over the connection to the computer and storing the data using the computer's high-capacity storage device. In addition to having all of the general disadvantages described above with respect to conventional backup solutions, this technique has the additional disadvantage of requiring the mobile computing device to be connected to a computer to perform a backup or restore operation. Because mobile computing devices are typically used in transit, it may be inconvenient or infeasible to connect a mobile computing device to a computer on a regular basis in order to perform backups. Similarly, when it is necessary to restore data to a mobile computing device, it may be inconvenient or infeasible to connect the mobile computing device to a computer on which the necessary data are stored.

Furthermore, even when it is possible to connect a mobile computing device to a computer to perform a backup or restore operation, it is particularly desirable that such operations be easy to perform. Users of mobile computing devices typically use such devices while traveling and therefore may not have the time to engage in lengthy and complicated interactions with backup software and hardware. Furthermore, mobile computer users may not have easy access, while in transit, to technical support staff or other technical assistance should they encounter difficulty performing a backup or restore. Therefore, it is particularly important that backup solutions for mobile computing devices be particularly easy to operate.

Mobile devices are also particularly susceptible to being lost, along with all of the data they contain. It may, in fact, be more likely that a mobile computer device be lost than that some of the data stored on it become corrupted or erased. It is therefore desirable that backup solutions for use with mobile computing devices be capable of easily backing up and restoring all of the data stored on such devices so that the data can be restored to a new device if an existing one is lost.

What is needed, therefore, are improved techniques for backing up and restoring data stored on mobile computing devices.

### SUMMARY

Techniques are disclosed for backing up or restoring the state of a mobile computing device in response to a single action performed by a user. A user may, for example, insert the mobile computing device into a cradle and press a “backup” button on the cradle or device, in response to which the state of the mobile computing device may be backed up to persistent storage media, such as a hard disk, in the cradle. Similarly, a user may insert the mobile computing device into the cradle and press a “restore” button on the cradle or device, in response to which the saved state of the mobile computing device may be restored. State that may be backed up to the cradle includes the contents of persistent media, RAM, and CMOS in the mobile storage device.

For example, in one aspect of the present invention, techniques are provided for use in a system including a computing device coupled to a cradle. The techniques include: (A) receiving a single backup initiation input action from a user; (B) in response to the single backup initiation input action, transferring, from a hard disk drive and random access memory of the computing device to the cradle, state information descriptive of a state of the device; and (C) storing the state information in a hard disk drive of the cradle.

In another aspect of the present invention, techniques are provided for use in a system including a computing device coupled to a cradle. The techniques include: (A) receiving a single restore initiation input action from a user; (B) in response to the single restore initiation input action, transferring, from a hard disk drive of the cradle to the computing device, state information descriptive of a device state; and (C) storing the state information in a hard disk drive and at least one component in the group consisting of a CMOS of the computing device and a system chipset of the computing device to put the computing device into the device state.

In a further aspect of the present invention, techniques are provided for use in a system including a computing device coupled to a cradle. The computing device includes a hard disk drive. The techniques include: (A) receiving a backup initiation input from a user; (B) in response to the backup initiation input, transferring to the cradle, from the hard disk drive of the computing device and at least one component in the group consisting of a CMOS of the computing device and a system chipset of the computing device, state information descriptive of a state of the computing device; and (C) storing the state information in a hard disk drive of the cradle.

In yet a further aspect of the present invention, techniques are provided for use in a system including a computing device coupled to a cradle. The computing device includes a hard disk drive. The techniques include: (A) receiving a restore initiation input from a user; (B) in response to the restore initiation input, transferring, from a hard disk drive of the cradle to the computing device, state information descriptive of a state of a random access memory of the computing device and at least one component in the group consisting of a CMOS of the computing device and a system chipset of the computing device; and (C) storing the state information in the hard disk drive of the computing device.

In yet another aspect of the present invention, techniques are provided for use in a system including a computing device coupled to a cradle. The cradle includes a hard disk drive. The techniques include: (A) receiving a backup initiation input from a User; (B) in response to the backup initiation input, transferring to the cradle, from a hard disk drive of the computing device and at least one component in the group consisting of a CMOS of the computing device and a system chipset of the computing device, state information descriptive of a state of the computing device; and (C) storing the state information in the hard disk drive of the cradle.

In a further aspect of the present invention, techniques are provided for use in a system including a computing device coupled to a cradle. The cradle includes a hard disk drive. The techniques include: (A) receiving a restore initiation input from a user; (B) in response to the restore initiation input, transferring, from the hard disk drive of the cradle to the computing device, state information descriptive of a state of the computing device; and (C) storing the state information in a hard disk drive of the computing device and at least one component in the group consisting of a CMOS of the computing device and a system chipset of the computing device.

In yet a further aspect of the present invention, techniques are provided for: (A) receiving a backup initiation input from a user; (B) in response to the backup initiation input, transferring, from a random access memory of a computing device and at least one component in the group consisting of a CMOS of the computing device and a system chipset of the computing device, state information descriptive of a state of the device; and (C) storing the state information in a hard disk drive of a cradle coupled to the computing device.

In yet another aspect of the present invention, techniques are provided for: (A) receiving a restore initiation input from a user; (B) in response to the restore initiation input, transferring, from a hard disk drive of a cradle to a computing device coupled to the cradle, state information descriptive of a state of the computing device; and (C) storing the state information in a random access memory of the computing device and at least one component in the group consisting of a CMOS of the computing device and a system chipset of the computing device.

Other features and advantages of various aspects and embodiments of the present invention will become apparent from the following description and from the claims.

### BRIEF DESCRIPTION OF THE DRAWINGS

FIG. 1A is a block diagram of a system for performing a backup operation according to first embodiment of the present invention;

FIG. 1B is a block diagram of a system for performing a backup operation according to a second embodiment of the present invention;

FIG. 2 is a flowchart of a method that may be performed by the system of FIG. 1A or FIG. 1B to back up the state of a mobile computing device in response to performance of a backup initiation action by a user;

FIG. 3 is a block diagram of a system for performing a restore operation according to one embodiment of the present invention;

FIG. 4 is a flowchart of a method that may be performed by the system of FIG. 3 to restore the state of a mobile computing device in response to performance of a restore initiation action by a user;

FIG. 5A is a front perspective view of the mobile computing device of FIG. 1A according to one embodiment of the present invention;

FIG. 5B is a front perspective, view of the cradle of FIG. 1A according to one embodiment of the present invention; and

FIG. 5C is a front perspective view of the mobile computing device of FIG. 5A when seated in the cradle of FIG. 5B according to one embodiment of the present invention.

### DETAILED DESCRIPTION

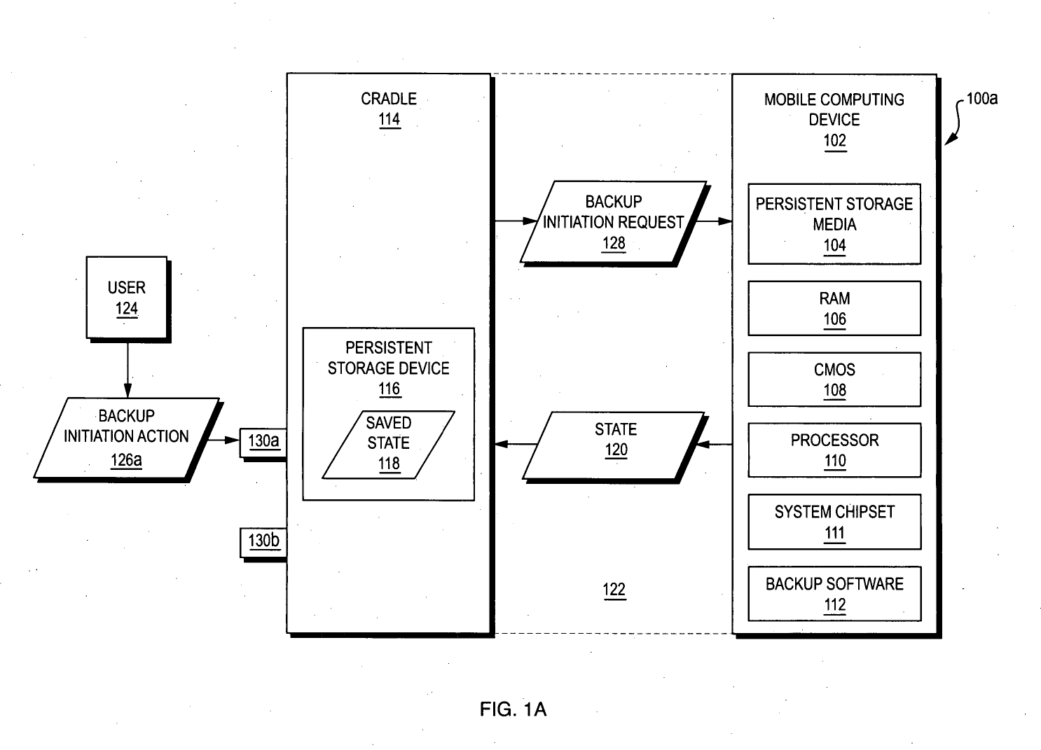

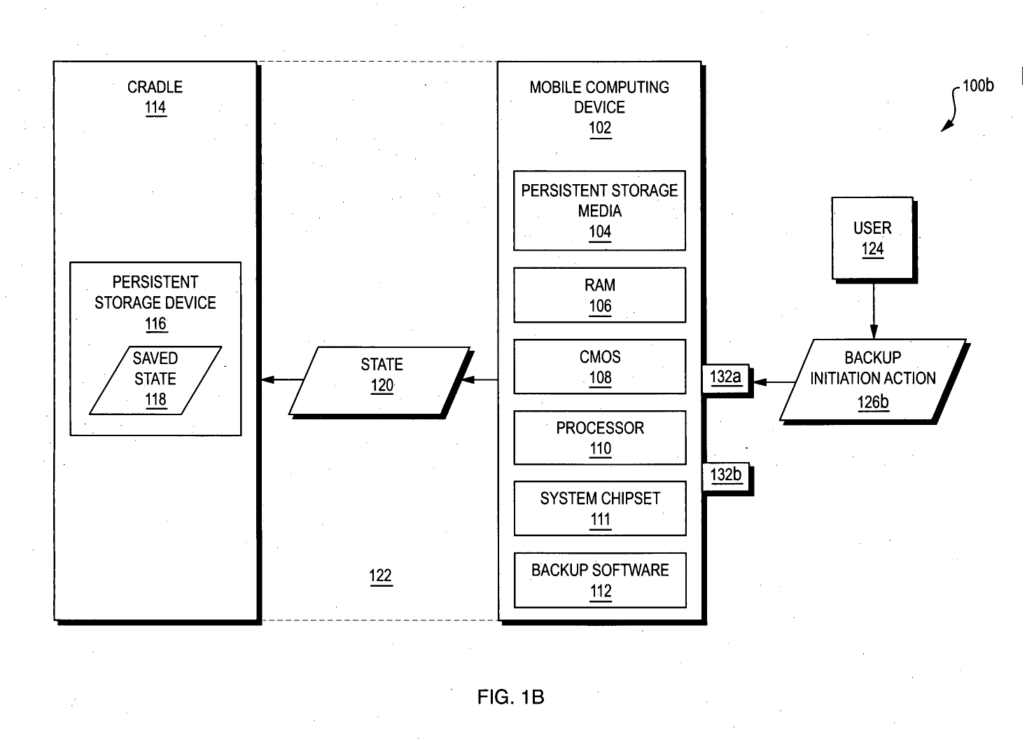

Referring to FIG. 1A, a block diagram is shown of a system 100a for performing a backup operation according to one embodiment of the present invention. The system 100a includes a mobile computing device 102 and a cradle 114 to which the mobile computing device 102 may be coupled.

The mobile computing device 102 may include all of the functional modules of a “computing system,” as that term is defined below. The mobile computing device 102 may therefore be an example of a computer. The mobile computing device 102 may, for example, provide computing power comparable to that of conventional laptop computers and execute an operating system (such as the Microsoft® Windows® 2000 Professional operating system) and application software (such as the Microsoft® Office business application suite) comparable to that executed by conventional personal (desktop and laptop) computers. Such operating systems are typically not found in appliances, as that term is defined below.

More specifically, in the embodiment illustrated in FIG. 1A, the mobile computing device 102 includes one or more persistent storage media 104. For example, the mobile computing device 102 may include a hard disk drive, and the persistent storage media 104 may be one or more hard disks within the hard disk drive. The persistent storage media 104 may contain a variety of data, such as application programs and other software, as well as content such as text files, image files, video files, audio files, and databases. One example of a hard disk drive that may be used in the mobile computing device 102 is the model MK2003GAH hard disk drive from Toshiba America Electronic Components, Inc. of Irvine, Calif. The persistent storage media 104 and the persistent storage device(s) used to access the persistent storage media 104 are an example of a storage subsystem.

The mobile computing device 102 also includes a random access memory (RAM) 106 that serves as the main memory of the mobile computing device 102. In one embodiment of the present invention, the RAM 106 is 256 MB of RAM, such as 8×256 Mbit DDR SDRAM available from Nanya Technology Corp. of Linkou, Taiwan. The mobile computing device 102 also includes a processor 110. In one embodiment of the present invention, the processor 110 is a Crusoe 0.13 micron TM5800 processor from Transmeta Corporation of Santa Clara, Calif. The processor 110 and RAM 106 are examples of components that may be used to implement a processing subsystem in the mobile computing device 102.

The mobile computing device 102 also includes a complementary metal oxide semiconductor (CMOS) 108 for persistently storing BIOS (basic input/output system) settings and other system information for the mobile computing device 102. A CMOS typically has very low power requirements, and is typically battery-powered so that it may retain the information that it stores even when the computing device to which it is connected (e.g., the mobile computing device 102) is turned off. Data that are typically stored in a CMOS include: (1) the current date, (2) the current time, (3) whether daylight savings time adjustment is enabled; (4) parameters for any attached hard disk drives; and (5) parameters for any attached floppy disk drives. Different CMOS memories may be capable of storing additional parameters, and the present invention is not limited to use with any particular kind of CMOS or any particular set of CMOS data. More generally, the CMOS 108 represents any memory or storage medium that may persistently store system settings, and is not limited to implementation as a CMOS. Techniques for reading data from and writing data to CMOS memories are well-known to those of ordinary skill in the art.

The mobile computing device 102 also includes a system chipset 111. In general, the term “chipset” refers to a number of integrated circuits designed to perform one or more related functions. Newer chipsets generally include functions provided by two or more older chipsets. In some cases, older chipsets that required two or more physical chips can be replaced with a chipset on one chip. The term “chipset” is often used to refer generally to the core functionality of a motherboard. As is well known to those having ordinary skill in the art, a chipset may contain state information stored in registers and other forms of memory.

The mobile computing device 102 also includes backup software 112 which may be stored in the persistent storage media 104 and/or RAM 106 and which may execute on the processor 110. Operations that may be performed by the backup software 112 will be described in more detail below.

In one embodiment of the present invention, the mobile computing device 102 includes, in addition to the components described above: a five-inch, high-resolution super-bright VGA color LCD, such as a 5-inch Transflective WVGA TFT LCD (800*480, 64 k color) active-matrix transflective color display from Samsung Electronics, Ltd. of Hong Kong; a ClearPad™ touchscreen from Synaptics Incorporated of San Jose, Calif.; an advanced lithium polymer battery such as the UP295385 Li-polymer battery cell from Sony Electronics, Inc. of Park Ridge, N.J.; input/output ports for IEEE 1394 (FireWire), Universal Serial Bus (USB), audio in/out, and a docking connector; and built-in 802.11 and Bluetooth wireless networking. In one embodiment, the mobile computing device 102 is 4.1″ (105 mm) wide×2.9″ (74 mm) long×0.9″ (22 mm) thick and weighs less than 9 ounces (250 grams).

The cradle 114 includes a persistent storage device 116, such as a hard disk drive. The cradle 114 may also include a processor or controller (not shown) for performing the functions described herein. The cradle 114 may, for example, include the same model of processor and hard disk drive as the mobile computing device 102. Those of ordinary skill in the art will appreciate how to configure a processor or controller to perform the functions described herein with respect to the cradle 114.

The cradle 114 also includes a backup button 130a. Examples of ways in which the backup button 130a may be used will now be described.

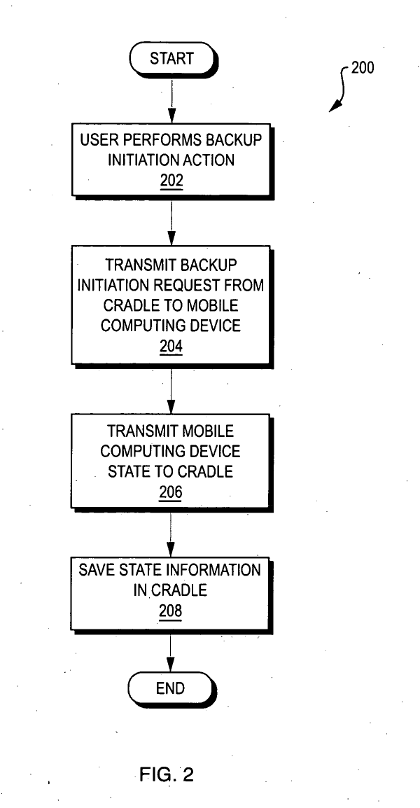

In one embodiment of the present invention, the system 100a may back up the state of the mobile computing device 102 to the cradle's persistent storage device 116 in response to performance of a single backup initiation action 126a by a user 124. For example, referring to FIG. 2, a flowchart is shown of a method 200 that may be performed by the system 100a to back up the state of the mobile computing device 102 in response to performance of the backup initiation action 126a by the user 124.

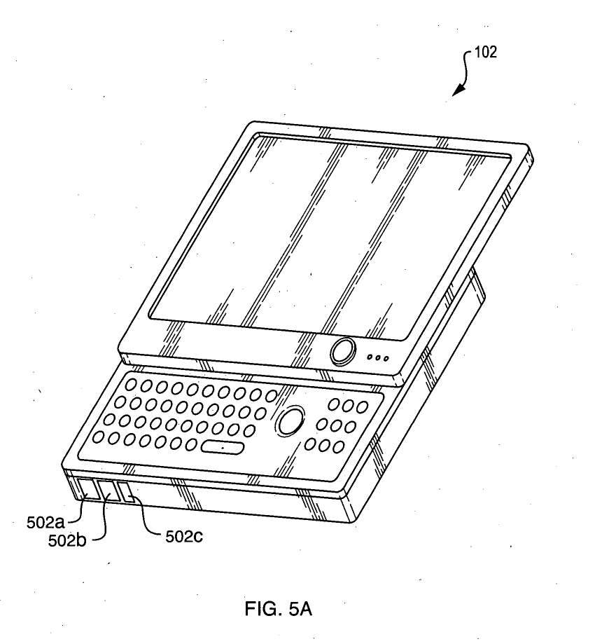

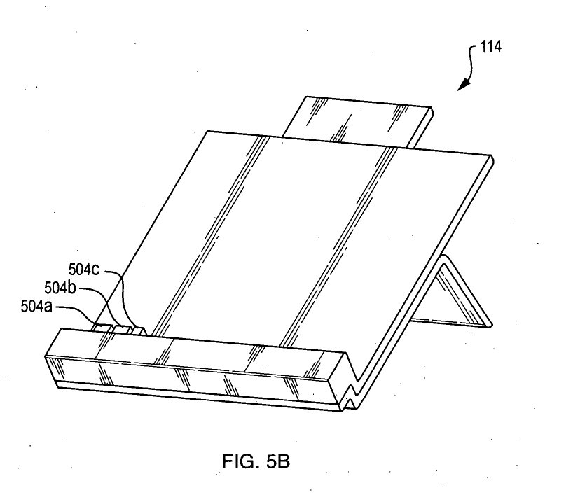

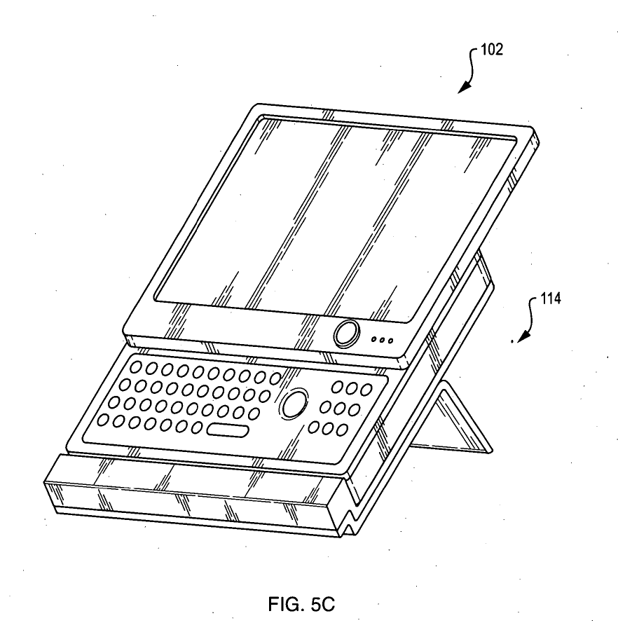

Prior to initiation of the method 200, the user 124 may establish a connection 122 between the mobile computing device 102 and the cradle 114 by, for example, placing the mobile computing device 102 in a seat of the cradle 114. For example, referring to FIG. 5A, a front perspective view is shown of the mobile computing device 102 according to one embodiment of the present invention. Referring to FIG. 5B, a front perspective view is shown of the cradle 114 according to one embodiment of the present invention. The mobile computing device 102 may be equipped with one or more connectors (e.g., connectors 502a-c) that mate with a corresponding port(s) (e.g., ports 504a-c) of the cradle 114 upon being placed in the cradle seat. For example, in one embodiment of the present invention, the mobile computing device 102 includes a Molex® 55768-1411 connector, a Molex® 55768-3611, and a power connector which may, for example, be any of a variety of conventional power connectors.

Referring to FIG. 5C, a front perspective view is shown of the mobile computing device 102 once the user has seated it in the cradle 114. When seated in the cradle, connectors 502a-c on the device 102 are coupled to ports 504a-c on the cradle, thereby enabling the cradle 114 to provide power to the device 102 and enabling data to be communicated between the device 102 and cradle 114. Furthermore, in the examples illustrated in FIGS. 5A-5C, cradle 114 includes a backup button 130a and a restore button 130b.

After establishing the connection 122, the user 124 may perform the backup initiation action 126a at the cradle 114 (step 202). For example, the cradle 114 may include backup button 130a and restore button 130b. The backup and restore buttons 130a-b may be designated as such using textual labels, distinctive colors, or other visual indicia of their function. The user 124 may, for example, perform the backup initiation action 126a by pressing the backup button 130a once.

In response to receiving the backup initiation action 126a from the user 124, the cradle 114 may transmit a backup initiation request 128 over the connection 122 to the mobile computing device 102 (step 204).

In response to receiving the backup initiation request 128, the backup software 112 executing on the mobile computing device 102 may transmit state information 120 representing some or all of the current state of the mobile computing device 102 to the cradle 114 over the connection 122 (step 206). The state 120 may include, for example, some or all of the data stored on the persistent storage media 104, some or all of the information stored in the RAM 106, some or all of the information stored in the CMOS 108, some or all of the information stored in the system chipset 111, or any combination thereof.

Note that the mobile computing device 102 may include a backup button instead of or in addition to the backup button 130a on the cradle 114. For example, referring to FIG. 1B, a block diagram is shown of a system 100b for performing a backup operation according to an embodiment of the present invention in which the mobile computing device includes a backup button 132a and a restore button 132b.

As in the system 100a illustrated in FIG. 1A, the user 124 may establish connection 122 between the mobile computing device 102 and the cradle 114. After establishing the connection 122, the user 124 may perform the backup initiation action 126b at the mobile computing device 102 (step 202). The user 124 may, for example, perform the backup initiation action 126b by pressing the backup button 132a once.

There is no need for the backup initiation request 128 (FIG. 1A) in the system 100b illustrated in FIG. 1B. Therefore, step 204 may be omitted in the system 100b illustrated in FIG. 1B. In response to performance of the backup initiation action 126b, the backup software 112 executing on the mobile computing device 102 may transmit state information 120 representing some or all of the current state of the mobile computing device 102 to the cradle 114 over the connection 122 (step 206).

For example, in one embodiment of the present invention, the state information 120 includes all of the information stored in the persistent storage media 104 and all of the information stored in the CMOS 108. In such an embodiment, the state information 120 represents a “snapshot” of the current persistent state of the mobile computing device 102, thereby enabling the persistent state of the mobile computing device 102 to be restored at a subsequent time if necessary or desired, as described in more detail below.

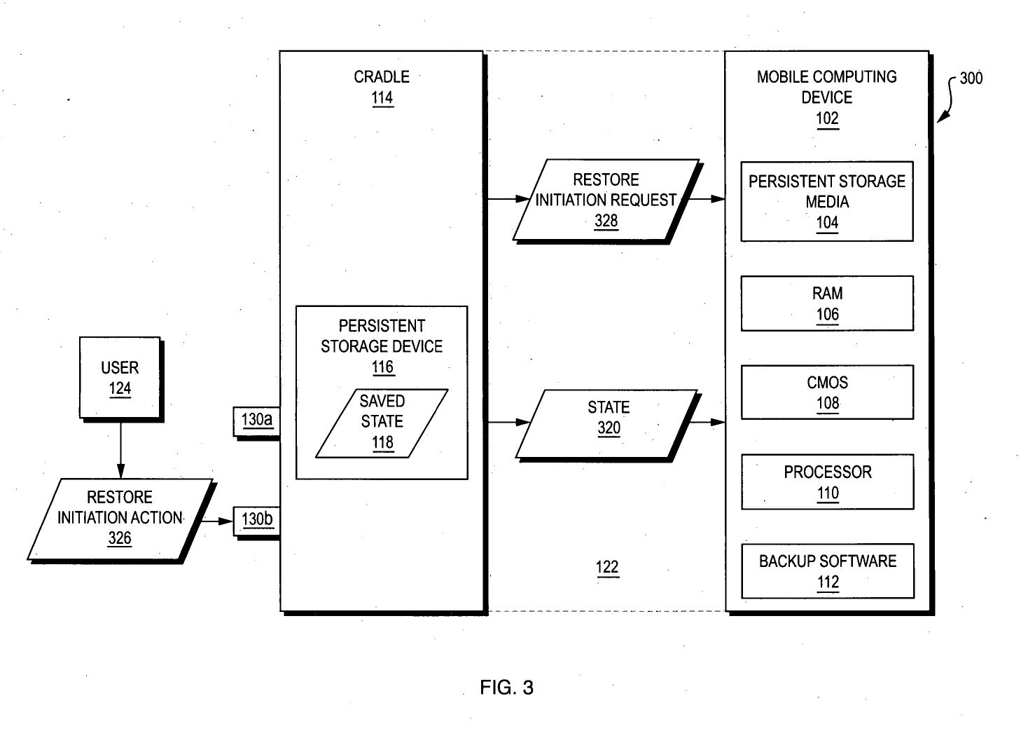

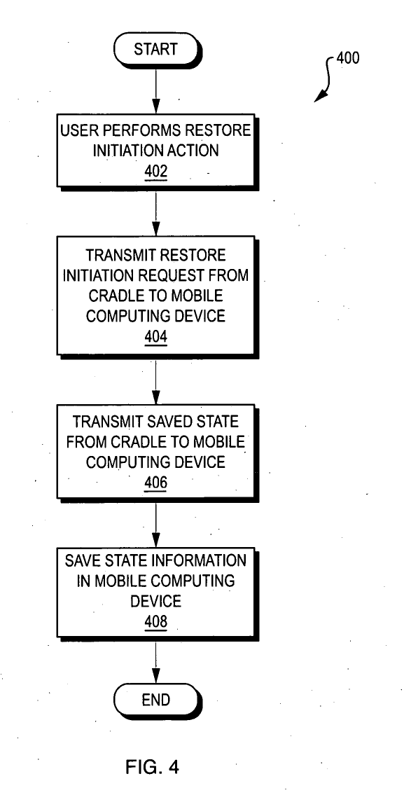

The cradle 114 receives the state information 120 and stores it as saved state information 118 in the persistent storage device 116 (step 208). Step 208 may be performed under control of the backup software 112. If, for example, the persistent storage device 116 is a hard disk drive, the cradle 114 may store the saved state information 118 in one or more files on the hard disk drive. State information retrieved from the persistent storage media 104, RAM 106, and CMOS 108 may be tagged when saved in the saved state information 118, so that such information may be restored to the appropriate storage medium when a restore operation (FIGS. 3-4) is performed. Upon completion of the method 200, the mobile computing device 102 may be removed from the cradle 114 and continue to be used by the user 124.

Because the backup operation performed by steps 204-208 does not require the involvement of the user 124, and because the backup operation is initiated by the single backup initiation action 126a performed by the user 124 in step 202, the method 200 effectively backs up the state of the mobile computing device 102 in response to the single action 126a of the user 124.

The method 200 illustrated in FIG. 2 may be implemented in any of a variety of ways. For example, the backup initiation request 128 may be transmitted over a USB (Universal Serial Bus) interface. The cradle 114 may, for example, emulate a keyboard and transmit the backup initiation request 128 as a special key sequence to a software program that is resident in the RAM 106 of the mobile computing device 102. Alternatively, for example, the cradle 114 may transmit the backup initiation request 128 through the power interface connecting the cradle 114 to the device 102.

The mobile computing device 102 may, for example, initiate a “suspend-to-RAM” operation, causing the device 102 to enter an “S3” state, in which the states of the processor 110 and chipset 111 are saved to the RAM 106. Alternatively, for example, the mobile computing device 102 may initiate a “suspend-to-disk” operation, causing the device 102 to enter an “S4” state, in which the states of the processor 110, chipset 111, and RAM 106 are saved to the persistent storage media 104. Both of these operations may be performed by versions of the Microsoft® Windows operating system.

The backup software 112 may instruct a power management processor in the device 102 that a backup operation is being initiated. Upon completion of either kind of suspend operation just described, a power management processor 102 in the mobile computing device 102 may, upon determining that a backup operation is being performed, initiate a power-up sequence in the device 102 and inform the BIOS in the device 102 that a backup operation (rather than a normal resume from an S3 or S4 state) is being performed. In response, the BIOS may transmit the stored state (e.g., the state of the CMOS 108 and media 104 in the case of an S4 operation or the state of the CMOS 108, media 104, and RAM 106 in the case of an S3 operation) to the cradle 114, which may save the transmitted state in the persistent storage device 116.

Once the data 118 are saved in the cradle 114, the BIOS may allow a normal resume from an S3 or S4 state to occur. Upon completion of this resume operation, the mobile computing device 102 will be in the same state as it was in just prior to performance of the backup operation. In this way, the state of the mobile computing device 102 may be backed up to the cradle 114 while the device 102 is running.

Referring to FIG. 3, a block diagram is shown of a system 300 for performing a restore operation according to one embodiment of the present invention. The system 300 includes the mobile computing device 102 and the cradle 114, described above with respect to FIG. 1A.

In one embodiment of the present invention, the system 300 may restore the saved state 118 to the mobile computing device 102 (or to another mobile computing device of the same kind) from the persistent storage device 116 of the cradle 114 in response to performance of a single restore initiation action 326 by the user 124. For example, referring to FIG. 4, a flowchart is shown of a method 400 that may be performed by the system 300 to restore up the saved state 118 to the mobile computing device 102 in response to performance of the restore initiation action 326 by the user 124.

Prior to initiation of the method 400, the user 124 may establish the connection 122 between the mobile computing device 102 and the cradle 114 by, for example, placing the mobile computing device 102 in the seat of the cradle 114. After establishing the connection 122, the user 124 may perform the restore initiation action 126a at the cradle 114 (step 402). The user 124 may, for example, perform the restore initiation action 326 by pressing the restore button 130b once.

In response to receiving the restore initiation action 326 from the user 124, the cradle 114 may transmit a restore initiation request 328 over the connection 122 to the mobile computing device 102 (step 404).

In response to receiving the restore initiation request 328, the backup software 112 executing on the mobile computing device 102 may transmit some or all of the saved state information 320 from the cradle 114 to the mobile computing device 102 over the connection 122 (step 406). In one embodiment of the present invention, all of the saved state information 118 is transmitted to the mobile computing device 102 by default.

The backup software 112 saves the saved state information 320 in the mobile computing device 102, thereby replacing the current state of the mobile computing device 102 with the state represented by the saved state information 320 (step 408). As described above with respect to FIGS. 1-2, the saved state information 118 may include information previously stored in the persistent storage media 104, RAM 106, CMOS 108, or any combination thereof. The backup software 112 may copy portions of the saved state information 320 into appropriate ones of the persistent storage media 104, RAM 106, and CMOS 108, so that the state of the mobile computing device 102 is properly restored.

The result of the restore operation performed by the method 400 is that the state of the mobile computing device 102 is restored to the state that it was in when the backup method 200 was performed. Upon completion of the method 400, the mobile computing device 102 may be removed from the cradle 114 and be used by the user 124.

Because the restore operation performed by steps 404-408 does not require the involvement of the user 124, and because the restore operation is initiated by the single restore initiation action 326 performed by the user 124 in step 402, the method 400 effectively backs up the state of the mobile computing device 102 in response to the single action 326 of the user 124.

Restoration of information stored in the CMOS 108 or other similar memory may require particular steps to be taken because modifying such memory while the mobile computing device's operating system is executing may cause problems. If, for example, the mobile computing device 102 executes a version of the Microsoft® Windows® operating system, part of the backup software 112 may be implemented as a driver program which terminates the operating system (after the backup software 112 restores the state of the persistent storage media 104) and then runs a DOS program which restores the CMOS state and then reboots the mobile computing device 102 to complete the restore operation.

The method 400 illustrated in FIG. 4 may be implemented in any of a variety of ways. For example, the cradle 114 may include a chip which connects to a USB port connected to the mobile device 102. This chip may emulate a CD-ROM drive, and the BIOS in the mobile computing device 102 may be capable of booting the mobile computing device 102 from a USB CD drive.

In one embodiment of the present invention, in response to the restore initiation action 326 (e.g., pressing the restore button 130b) the cradle 114 activates the virtual CD-ROM drive and initiates a reset of the mobile computing device 102. During the reset, the mobile computing device 102 boots from the virtual CD-ROM drive, causing the device 102 to load a minimal operating system and the backup software 112. The backup software 112 initiates the restore process, which includes steps 406 and 408 of method 400 (FIG. 4), thereby restoring the saved stated 118 into the mobile computing device 102. The backup software 112 then initiates a resume-from-suspend operation, causing the operating system on the mobile computing device 102 to resume operation as it if were resuming from a normal suspend operation rather than a restore.

Most conventional computing systems are composed of subsystems, also referred to herein as “functional modules” or simply as “modules.” For example, a conventional computing system may include one or more of each of the following subsystems: (1) an information processing subsystem (which may include, for example, a central processing unit (CPU)), (2) a power input and distribution subsystem (which may include, for example, a power supply and power bus), (3) a user input subsystem (which may include, for example, a conventional mouse and/or keyboard), (4) a user output subsystem (which may include, for example, a conventional monitor and/or printer), (5) a mass media storage and access subsystem (which may include, for example, a conventional hard disk drive), and (6) a network or inter-device communication subsystem (which may include, for example, a conventional network interface card (NIC) or a serial or parallel cable). The relationship of functional modules to physical components in computer systems is described in more detail in the commonly-owned patent application Ser. No. 10/173,734, entitled “Modular Computing System,” filed on Jun. 18, 2002, hereby incorporated by reference.

As used herein, the term “functional module” refers to a set of hardware and/or software in a computing system that performs a particular function. The terms “subsystem” and “module” are used synonymously with “functional module” herein. For example, a display module in a conventional desktop computer may include the computer's CPU, graphics card, video memory, monitor, and portions of the operating system that process display information. Examples of other modules include processing modules, input modules, and power modules. A functional module may be embodied in hardware, software, data and/or instruction streams, and any combination thereof. A single physical device in a computer system may be part of more than one functional module.

As used herein, the term “computer” refers to a system that includes an information processing module, a power module, a user input module, a user output module, and a storage module. These modules are interconnected to form a unified system that is powered by the power module, receives user input using the user input module, processes the user input (and other information) using the processing module, provides user output using the user output module, and stores user input (and other information) using the storage module. Examples of computers include conventional desktop computers and laptop computers.

As used herein, the term “appliance” refers to a device that includes a power module, a user input module, and a user output module, but that lacks components that provide some or all of the functionality of a conventional computer processing module and/or storage module. An appliance therefore may rely at least in part on a connection to a network system or removable media to provide the missing functionality of the processing and/or media storage modules. The modules in an appliance are interconnected to form a unified system that is powered by the power module, receives user input using the user input module, processes the user input (and other information) using the (at least partially external) processing module, provides user output using the user output module, and stores user input (and other information) using the (at least partially external) storage module. Examples of appliances include personal digital assistants, cellular telephones, and web pads.

As used herein, the term “computing system” refers to both computers and appliances. A computing system includes an input module, an output module, a power module, a processing module, and a storage module. A computing system may also include other modules, such as an interdevice communication module.

One well-known implementation of a modular computing system is the conventional desktop computer, which typically includes a processing module, a networking module, an input module, an output module, a storage module, and a power module.

As used herein, the term “input module” refers to any functional module (subsystem) that provides input to a computing system. Input modules may include devices such as keyboards, mice, styluses, trackballs, touch location devices such as touchpads and touch screens, microphones, scanners, cameras and video capture devices, wireless receivers, buttons, and switches. Input may, for example, be obtained by the input module as the result of actions performed by a user (such as typing on a keyboard). Input may, however, be obtained without user activity. For example, a network interface card may receive input over a network from another computer performing automated actions, and a digital camera may be configured to periodically capture images and provide them as input to a computing system without further interaction from the user.

As used herein, the term “output module” refers to any functional module (subsystem) that provides output to a user, to another module, or to another computing device. Output modules may include, for example, devices such as display monitors, speakers, printers, projectors, and wireless transmitters.

As used herein, the term “processing module” refers to any functional module (subsystem) that processes information. Processing modules may include one or more kinds of processor in any combination, such as a central processing unit (CPU), graphics processing unit, math co-processing unit, or a digital signal processor.

As used herein, the term “storage module” refers to any functional module (subsystem) that stores digital information. Storage modules may include devices such as RAM, ROM, hard disk drives, floppy disk drives, optical drives (such as CD-ROM, CD-R, CD-RW, DVD-RAM, or DVD-ROM drives), or tape drives.

As used herein, the term “interdevice communication module” refers to any functional module (subsystem) that enables a component to communicate with another component. Typically, each component that is to communicate with another component contains its own interdevice communication module. Interdevice communication modules may enable communication over any kind of connection, such as serial cables, parallel cables, USB cables, or wireless connections. Interdevice communication modules may include devices such as serial controllers, parallel controllers, and network interface cards (NICs).

In a desktop computer, the entire processing module, the-entire networking module, and most or all of the media storage module are typically embodied in components contained within a single physical housing. Although such housings have various form factors, some of which (such as the “tower” model) are designed to rest on a floor rather than a desk, all such form factors fall within the desktop computer paradigm as described herein. For purposes of explanation, any such housing and the devices contained within it are referred to herein as the “desktop component” of a desktop computer.

For example, a typical desktop computer system includes a desktop component, a keyboard, a mouse, a monitor, and a printer. The processing module of the desktop computer is embodied in a central processing unit (CPU) and related components within the desktop component. Similarly, the networking module of the desktop computer is embodied in a network interface card (NIC) and related components within the desktop component, and the power module of the desktop computer is embodied in a power supply, transformer, and related components within the desktop component. The input module of the desktop computer consists of a keyboard, a mouse, and related components within the desktop component. The output module of the desktop computer consists of a monitor, a printer, and related components within the desktop component. The storage module of the desktop computer consists of a hard disk drive (not shown) within the desktop component, an external optical storage device, and related components within the desktop component. The “related components” described above typically include device drivers and other hardware and software for communicating with and controlling the keyboard, mouse, monitor, printer, and optical storage device, which are typically referred to as “peripheral devices.”

Conventional desktop components typically communicate with peripheral devices (such as the keyboard and the printer) via data ports, wireless streams, or physical connectors having various bandwidths and form factors and employing various protocols. Such peripheral devices are generally powered either independently by power modules unique to each device, or draw power parasitically from the desktop component.

In portable (mobile) computing systems, such as laptop computers, a single device often encapsulates a set of components that embody user input modules (e.g., keyboard, trackpad, touchpad, buttons, levers, touchscreen, stylus, operating system, etc.), user output modules (e.g., monitor, speakers, LEDs, vibration, etc.), processing modules (e.g., CPU, memory, video processor, decoder), media storage modules (e.g., hard disk drive, flash memory, smart card, ROM), and power modules (e.g., batteries, transformers, super capacitors, solar cells, springs). Encapsulation of input, output, and power modules within a single device is a common way in which portable computing systems address the need for portability. In addition to this encapsulation of multiple functional modules within a single device, portable computing systems often also include peripheral devices that provide the functionality of network modules (e.g., modems), inter-device communication modules (e.g., port replicators, expansion cards), user input modules (e.g., mice, keyboards, microphones), user output modules (e.g., printers, external speakers), and power modules (e.g., external batteries and chargers).

Laptop computers, handheld computers, and personal digital assistants (PDAs) are examples of such portable computing systems. Devices such as MP3 players, calculators, and handheld voice recorders are also portable computing systems with processing, input, output, power, and media modules specifically scaled and tailored to these niche devices. Among portable computing systems are also specialized “media readers” such as digital phones, pagers, digital cameras, tape players, CD players, wireless email devices, portable DVD-players, mini-disc players, and portable game players, which read a stream of media to the user, either from a wireless source or from a removable media source. These readers, like appliances, may have some or all of their processing or media storage modules abstracted over a network or removable device.

Among the advantages of the invention are one or more of the following.

Techniques disclosed herein may be used to enable the processes of backing up and restoring the state of the mobile computing device 102 in response to a single action performed by the user. Such techniques therefore greatly simplify the backup/restore process from the perspective of the user in comparison to systems which require the user to engage in many steps to perform a backup or restore operation. The techniques disclosed herein are particularly beneficial to the users of mobile computing devices, who may not have time to learn and engage in complex backup/restore procedures, and who may not have access to technical support staff or other technical support resources if they encounter difficulty performing a backup or restore operation.

In addition, the use of the cradle 114, rather than a cable, to connect the mobile computing device 102 to the corresponding backup device, further simplifies the backup and restore process. The use of the cradle 114 frees the user from the need to transport and use a separate cable which needs to be connected at both ends to the mobile computing device 102 and corresponding backup device. Rather, the user need merely insert the mobile computing device 102 itself into the cradle 114 (as shown in FIG. 5C), thereby establishing a connection between the two. This both simplifies the backup/restore process and requires fewer parts than a solution involving a cable and backup device.

Another advantage of techniques disclosed herein is that they may be employed to save both the contents of the persistent storage media 104 and the CMOS 108 in the mobile computing device 102. Although it may be useful to back up the contents of the persistent storage media 104 but not the CMOS 108, in such a case it may be necessary to perform additional configuration of the mobile computing device 102 after the completion of a restore operation (such as setting its system date and time) to completely restore the state of the mobile computing device 102 as it existed at the time the backup operation was performed. Backing up the contents of CMOS 108 in addition to the contents of the persistent storage media 104 makes it possible to replicate the state of the mobile computing device 102 more complete. This is yet another way in which the techniques disclosed herein simplify the process of restoring the state of the mobile computing device 102 quickly and completely.

Although such techniques are generally helpful in cases in which part of the state of the mobile computing device 102 becomes corrupted or erased, such techniques are also helpful in cases in which the original mobile computing device 102 is lost or unavailable. In such cases the techniques disclosed herein may be used to restore the saved state 118 to a different mobile computing device, thereby enabling it to be used as a replacement for the original mobile computing device 102 without any-additional manual setup or configuration.

Another advantage of techniques disclosed herein is that the cradle 114 itself may be small and lightweight, include a relatively small number of components, and be manufactured relatively inexpensively. The cradle 114 may, for example, be implemented with little more than a hard disk drive and controller, backup and restore buttons, and an input/output connector and path for communicating with the mobile computing device 102. The cradle 114 may therefore be easily transportable with the mobile computing device 102 and therefore be readily available for use to perform a restore operation if data on the mobile computing device 102 becomes erased or corrupted. Use of the cradle 114 also eliminates the need to connect the mobile computing device 102 to a personal computer to perform a backup or restore operation, further simplifying such processes. The cradle 114 may also double as a power charging station for the mobile computing device 102.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Although the backup and restore buttons 130a-b are illustrated and described herein as physical buttons, this is not a limitation of the present invention. Rather, the backup and restore buttons 130a-b may be implemented as any means for receiving a single action from the user 124. Each of the backup button 130a and the restore button 130b may, for example, be a lever, switch, or a virtual button displayed on a display screen such as a touch screen. Furthermore, the backup and restore buttons 130a-b may be implemented as a single button or other input means. For example, the cradle 114 may include a single “backup/restore” button rather than the two backup and restore buttons 130a-b. When the user presses such a backup/restore button, the operation to be performed may be selected based on other criteria or input, such as the length of time for which the button is pressed or the identity of an on-screen icon selected by the user.

Furthermore, the techniques disclosed herein are not limited to performing a backup/restore operation in response to a single action performed by the user. Rather, the techniques disclosed herein may be employed to perform backup/restore operations in response to multiple actions by the user.

The techniques disclosed herein are not limited to performing backup/restore operations in response to actions performed by the user 124 at the cradle 114. Rather, the mobile computing device 102 may be equipped with means (such as one or more buttons) for initiating a backup/restore operation. The user 124 may activate such means to perform a backup/restore operation. In such a case, the backup initiation request 128 and the restore initiation request 328 may either be unnecessary or may be transmitted by the mobile computing device 102 to the cradle 114 rather than vice versa.

Although the backup software 112 is described herein as executing on the mobile computing device 102, this is not a limitation of the present invention. Rather, the backup software 112 may additionally or alternatively execute on the cradle 114.

Although the mobile computing device 102 may be a computer, as that term is defined herein, this is not a requirement of the present invention. Rather, the mobile computing device 102 may be an “appliance” as that term is defined herein.

The particular mobile computing device 102 and cradle 114 shown in FIGS. 5A and 5B, respectively, are shown merely for purposes of example and do not constitute limitations of the present invention. More generally, the mobile computing device 102 and cradle 114 may have any form factor and appearance. The cradle 114 may be any device to which the mobile computing device 102 may be connected by placing the mobile computing device 102 into contact with the cradle 114 such that the mobile computing device 102 comes to be seated, at least in part, within the cradle 114.

The connection 122 between the cradle 114 and the mobile computing device 102 may be established using any kind of interface, such as a USB, FireWire (IEEE 1394), or PCI Split Bridge™ interfaces. Note that although the persistent storage device 116 is illustrated in FIGS. 1A-1B as a component of the cradle 114, this is not a requirement of the present invention. Rather, the persistent storage device 116 may, for example, be an external device that is connected to the cradle 114.

Note that the term “cradle” as used herein is not limited herein to an apparatus as shown in FIGS. 5A-5C. The cradle 114 may, for example, be a laptop docking station and the mobile computing device 102 may be a laptop computer. The use of a docking station in conjunction with a computing device, such as the computing device 102, is described in more detail in the above-referenced patent application entitled “Docking Station for Mobile Computing Device.” Embodiments of the docking station disclosed therein act as an interface between a computing device and one or more peripheral devices, such as monitors, keyboards, printers, and external storage devices (such as hard disk drives and optical media drives).

Elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a system including a device coupled to a cradle, a method comprising steps of:
(A) receiving a single backup initiation input action from a user;
(B) in response to the single backup initiation input action, transferring, from the device to the cradle, state information descriptive of a state of the device; and
(C) storing the state information in the cradle.

2. The method of claim 1, wherein the device comprises a computing device.

3. The method of claim 2, wherein the device comprises a hard disk drive, and wherein the step (B) comprises transferring information stored in the hard disk drive.

4. The method of claim 3, wherein the device further comprises a CMOS, and wherein the step (B) further comprises a step of transferring information stored in the CMOS.

5. The method of claim 4, wherein the device further comprises a RAM, and wherein the step (B) further comprises a step of transferring information stored in the RAM.

6. The method of claim 2, wherein the device comprises a system chipset, and wherein the step (B) comprises transferring information stored in the system chipset.

7. The method of claim 2, wherein the device comprises a laptop computer.

8. The method of claim 7, wherein the cradle comprises a docking station.

9. The method of claim 1, wherein the cradle comprises a hard disk drive, and wherein the step (C) comprises a step of storing the state information in the hard disk drive.

10. The method of claim 1, wherein the single backup initiation input comprises a press of a button on the cradle.

11. The method of claim 1, wherein the-single backup initiation input comprises a press of a button on the device.

12. In a system including a computing device coupled to a cradle, a method comprising steps of:
(A) receiving a single-backup initiation input action from a user;
(B) in response to the single backup initiation input action, transferring, from a hard disk drive and random access memory of the computing device to the cradle, state information descriptive of a state of the device; and
(C) storing the state information in a hard disk drive of the cradle.

13. An apparatus for use with a system including a computing device coupled to a cradle, the apparatus comprising:
means for receiving a single backup initiation input action from a user;
transference means, responsive to the single backup initiation input action, for transferring from the computing device to the cradle state information descriptive of a state of the computing device; and
means for storing the state information in the cradle.

14. The apparatus of claim 1, wherein the computing device comprises a hard disk drive, and wherein the transference means comprises means for transferring information stored in the hard disk drive.

15. The apparatus of claim 13, wherein the computing device further comprises a CMOS, and wherein the transference means further comprises means for transferring information stored in the CMOS.

16. The apparatus of claim 14, wherein the computing device further comprises a RAM, and wherein the transference means further comprises a step of transferring information stored in the RAM.

17. The apparatus of claim 15, wherein the computing device comprises a system chipset, and wherein the transference means comprises means for transferring information stored in the system chipset.

18. The apparatus of claim 13, wherein the cradle comprises a hard disk drive, and wherein the means for storing comprises-means for storing the state information in the hard disk drive.

19. The apparatus of claim 13, wherein the single backup initiation input comprises a press of a button on the cradle.

20. The apparatus of claim 13, wherein the single backup initiation input comprises a press of a button on the computing device.

21. In a system including a device coupled to a cradle, a method comprising steps of:
(A) receiving a single restore initiation input action from a user;
(B) in response to the single restore initiation input action, transferring, from the cradle to the device, state information descriptive of a device state; and
(C) storing the state information in the device to put the device into the device state.

22. The method of claim 21, wherein the device comprises a computing device.

23. The method of claim 22, wherein the device comprises a hard disk drive, and wherein the step (C) comprises storing at least some of the state information in the hard disk drive.

24. The method of claim 23, wherein the device further comprises a CMOS, and wherein the step (C) further comprises a step of storing at least some of the state information in the CMOS.

25. The method of claim 24, wherein the device further comprises a RAM, and wherein the step (C) further comprises a step of storing at least some of the state information in the RAM.

26. The method of claim 22, wherein the device further comprises a system chipset, and wherein the step (C) comprises transferring information stored in the system chipset.

27. The method of claim 22, wherein the device comprises a laptop computer.

28. The method of claim 27, wherein the cradle comprises a docking station.

29. The method of claim 21, wherein the cradle comprises a hard disk drive, and wherein the step (B) comprises a step of transferring the state information from the hard disk drive.

30. The method of claim 21, wherein the single restore initiation input comprises a press of a button on the cradle.

31. The method of claim 21, wherein the single restore initiation input comprises a press of a button on the device.

32. In a system including a computing device coupled to a cradle, a method comprising steps of:
(A) receiving a single restore initiation input action from a user;
(B) in response to the single restore initiation input action, transferring, from a hard disk drive of the cradle to the computing device, state information descriptive of a device state; and
(C) storing the state information in a hard disk drive and at least one component in the group consisting of a CMOS of the computing device and a system chipset of the computing device to put the computing device into the device state.

33. An apparatus for use with a system including a computing device coupled to a cradle, the apparatus comprising:
means for receiving a single restore initiation input action from a user;
transference means, responsive to the single restore initiation input action, for transferring from the cradle to the computing device state information descriptive of a device state; and
means for storing the state information in the computing device to put the computing device into the device state.

34. The apparatus of claim 33, wherein the computing device comprises a hard disk drive, and wherein the means for storing comprises means for storing at least some of the state information in the hard disk drive.

35. The apparatus of claim 34, wherein the computing device further comprises a CMOS, and wherein the means for storing further-comprises means for storing at least some of the state information in the CMOS.

36. The apparatus of claim 35, wherein the computing device further comprises a RAM, and wherein the means for storing further comprises means for storing at least some of the state information in the RAM.

37. The apparatus of claim 34, wherein the computing device further comprises a system chipset, and wherein the means for storing further comprises means for storing at least some of the state information in the system chipset.

38. The apparatus of claim 33, wherein the cradle comprises a hard disk drive, and wherein the transference means comprises means for transferring the state information from the hard disk drive.

39. The apparatus of claim 33, wherein the single restore initiation input comprises a press of a button on the cradle.

40. The apparatus of claim 33, wherein the single restore initiation input comprises a press of a button on the device.

41. In a system including a device coupled to a cradle, the device comprising a hard disk drive, a method comprising steps of:
(A) receiving a backup initiation input from a user;
(B) in response to the backup initiation input, transferring, from the hard disk drive of the device to the cradle, state information descriptive of a state of the device; and
(C) storing the state information in the cradle.

42. The method of claim 41, wherein the device comprises a computing device.

43. The method of claim 42, wherein the device further comprises a CMOS, and wherein the step (B) comprises a step of transferring information stored in the CMOS.

44. The method of claim 43, wherein the device further comprises a RAM, and wherein the step (B) further comprises a step of transferring information stored in the RAM.

45. The method of claim 42, wherein the device comprises a system chipset, and wherein the step (B) comprises transferring information stored in the system chipset.

46. The method of claim 42, wherein the device comprises a laptop computer, and wherein the cradle comprises a docking station.

47. The method of claim 41, wherein the cradle comprises a hard disk drive, and wherein the step (C) comprises a step of storing the state information in the hard disk drive.

48. In a system including a computing device coupled to a cradle, the computing device comprising a hard disk drive, a method comprising steps of:
(A) receiving a backup initiation input from a user;
(B) in response to the backup initiation input, transferring to the cradle, from the hard disk drive of the computing device and at least one component in the group consisting of a CMOS of the computing device and a system chipset of the computing device, state information descriptive of a state of the computing device; and
(C) storing the state information in a hard disk drive of the cradle.

49. An apparatus for use with a system including a device coupled to a cradle, the device comprising a hard disk drive, the apparatus comprising:
means receiving a backup initiation input from a user;
transference means, responsive to the backup initiation input, for transferring, from the hard disk drive of the device to the cradle, state information descriptive of a state of the device; and
means for storing the state information in the cradle.

50. The apparatus of claim 49, wherein the device comprises a computing device.

51. The apparatus of claim 50, wherein the device further comprises a CMOS, and wherein the transference means comprises means for transferring information stored in the CMOS.

52. The apparatus of claim 51, wherein the device further comprises a RAM, and wherein the transference means further comprises means for transferring information stored in the RAM.

53. The apparatus of claim 50, wherein the device comprises a system chipset, and wherein the transference means comprises means for transferring information stored in the system chipset.

54. The apparatus of claim 49, wherein the cradle comprises a hard disk drive, and wherein the means for storing comprises means for storing the state information in the hard disk drive.

55. In a system including a device coupled to a cradle, the device comprising a hard disk drive, a method comprising steps of:
(A) receiving a restore initiation input from a user;
(B) in response to the restore initiation input, transferring, from the cradle to the device, state information descriptive of a state of the device; and
(C) storing the state information in the hard disk drive of the device.

56. The method of claim 55, wherein the device comprises a computing device.

57. The method of claim 56, wherein the device further comprises a CMOS, and wherein the step (C) comprises a step of storing at least some of the state information in the CMOS.

58. The method of claim 57, wherein the device further comprises a RAM, and wherein the step (C) further comprises a step of storing at least some of the state information in the RAM.

59. The method of claim 56, wherein the device comprises a system chipset, and wherein the step (C) comprises transferring information stored in the system chipset.

60. The method of claim 56, wherein the device comprises a laptop computer, and wherein the cradle comprises a docking station.

61. The method of claim 55, wherein the cradle comprises a hard disk drive, and wherein the step (B) comprises a step of transferring the state information from the hard disk drive of the-cradle.

62. In a system including a computing device coupled to a cradle, the computing device comprising a hard disk drive, a method comprising steps of:
(A) receiving a restore initiation input from a user;
(B) in response to the restore initiation input, transferring, from a hard disk drive of the cradle to the computing device, state information descriptive of a state of a random access memory of the computing device and at least one component in the group consisting of a CMOS of the computing device and a system chipset of the computing device; and
(C) storing the state information in the hard disk drive of the computing device.

63. An apparatus for use with a system including a device coupled to a cradle, the device comprising a hard disk drive, the apparatus comprising:
means for receiving a restore initiation input from a user;
transference means, responsive to the restore initiation input, for transferring, from the cradle to the device, state information descriptive of a state of the device; and
means for storing the state information in the hard disk drive of the device.

64. The apparatus of claim 63, wherein the device comprises a computing device.

65. The apparatus of claim 64, wherein the device further comprises a CMOS, and wherein the means for storing comprises means for storing at least some of the state information in the CMOS.

66. The apparatus of claim 65, wherein the device further comprises a RAM, and wherein the means for storing further comprises means for storing at least some of the state information in the RAM.

67. The apparatus of claim 64, wherein the device comprises a system chipset, and wherein the means for storing comprises means for storing at least some of the state information in the system chipset.

68. The apparatus of claim 63, wherein the cradle comprises a hard disk drive, and wherein the transference means comprises means for transferring the state information from the hard disk drive of the cradle.

69. In a system including a device coupled to a cradle, the cradle comprising a hard disk drive, a method comprising steps of:
(A) receiving a backup initiation input from a user;
(B) in response to the backup initiation input, transferring, from the device to the cradle, state-information descriptive of a state of the device; and
(C) storing the state information in the hard disk drive of the cradle.

70. The method of claim 69, wherein the device comprises a computing device.

71. The method of claim 70, wherein the device comprises a hard disk drive, and wherein the step (B) comprises a step of transferring information stored in the hard disk drive.

72. The method of claim 71, wherein the device further comprises a CMOS, and wherein the step (B) comprises a step of transferring information stored in the CMOS.

73. The method of claim 72, wherein the device further comprises a RAM, and wherein the step (B) further comprises a step of transferring information stored in the RAM.

74. The method of claim 70, wherein the device comprises a system chipset, and wherein the step (B) comprises transferring information stored in the system chipset.

75. The method of claim 70, wherein the device comprises a laptop computer, and wherein the cradle comprises a docking station.

76. In a system including a computing device coupled to a cradle, the cradle comprising a hard disk drive, a method comprising steps of:
(A) receiving a backup initiation input from a user;
(B) in response to the backup initiation input, transferring to the cradle, from a hard disk drive of the computing device and at least one component in the group consisting of a CMOS of the computing device and a system chipset of the computing device, state information descriptive of a state of the computing device; and
(C) storing the state information in the hard disk drive of the cradle.

77. An apparatus for use with a system including a device coupled to a cradle, the cradle comprising a hard disk drive, the apparatus comprising:
means for receiving a backup initiation input from a user;
transference means, responsive to the backup initiation input, for transferring, from the device to the cradle, state information descriptive of a state of the device; and
means for storing the state information in the hard disk drive of the cradle.

78. The apparatus of claim 77, wherein the device comprises a hard disk drive, and wherein the transference means comprises means for transferring information stored in the hard disk drive.

79. The apparatus of claim 78, wherein the device further comprises a CMOS, and wherein the transference means further comprises means for transferring information stored in the CMOS.

80. The apparatus of claim 79, wherein the device further comprises a RAM, and wherein the transference means further comprises means for transferring information stored in the RAM.

81. The apparatus of claim 78, wherein the device comprises a system chipset, and wherein the transference means further comprises means for transferring information stored in the system chipset.

82. In a system including a device coupled to a cradle, the cradle comprising a hard disk drive, a method comprising steps of:
(A) receiving a restore initiation input from a user;
(B) in response to the restore initiation input, transferring, from the hard disk drive of the cradle to the device, state information descriptive of a state of the device; and
(C) storing the state information in the device.

83. The method of claim 82, wherein the device comprises a computing device.

84. The method of claim 83, wherein the device comprises a hard disk drive, and wherein the step (C) comprises a step of storing at least some of the state information in the hard disk drive of the device.

85. The method of claim 84, wherein the device further comprises a CMOS, and wherein the step (C) comprises a step of storing at least some of the state information in the CMOS.

86. The method of claim 85, wherein the device further comprises a RAM, and wherein the step (C) further comprises a step of storing at least some of the state information in the RAM.

87. The method of claim 84, wherein the device comprises a system chipset, and wherein the step (C) comprises transferring information stored in the system chipset.

88. The method of claim 84, wherein the device comprises a laptop computer, and wherein the cradle comprises a docking station.

89. In a system including a computing device coupled to a cradle, the cradle comprising a hard disk drive, a method comprising steps of:
(A) receiving a restore initiation input from a user;
(B) in response to the restore initiation input, transferring, from the hard disk drive of the cradle to the computing device, state information descriptive of a state of the computing device; and
(C) storing the state information in a hard disk drive of the computing device and at least one component in the group consisting of a CMOS of the computing device and a system chipset of the computing device.

90. An apparatus for use with a system including a device coupled to a cradle, the cradle comprising a hard disk drive, the apparatus comprising:
means for receiving a restore initiation input from a user;
transference means, responsive to the restore initiation input, for transferring, from the hard disk drive of the cradle to the device, state information descriptive of a state of the device; and
means for storing the state information in the device.

91. The apparatus of claim 90, wherein the device comprises a hard disk drive, and wherein the means for storing comprises means for storing at least some of the state information in the hard disk drive of the device.

92. The apparatus of claim 91, wherein the device further comprises a CMOS, and wherein the means for storing comprises means for storing at least some of the state information in the CMOS.

93. The apparatus of claim 92, wherein the device further comprises a RAM, and wherein the means for storing further comprises means for storing at least some of the state information in the RAM.

94. The apparatus of claim 91, wherein the device comprises a system chipset, and wherein the means for storing comprises means for storing at least some of the state information in the system chipset.

95. A method comprising steps of:
(A) receiving a backup initiation input from a user;
(B) in response to the backup initiation input, transferring, from a random access memory of a computing device and at least one component in the group consisting of a CMOS of the computing device and a system chipset of the computing device, state information descriptive of a state of the device; and
(C) storing the state information in a backup device.

96. The method of claim 95, wherein the backup device comprises a cradle, and wherein the computing device is coupled to the cradle.

97. The method of claim 96, wherein the computing device comprises a laptop computer and wherein the cradle comprises a docking station.

98. The method of claim 96, wherein the cradle comprises a hard disk drive, and wherein the step (C) comprises a step of storing the state information in the hard disk drive.

99. The method of claim 95, wherein the computing device comprises a laptop computer.

100. A method comprising steps of:
(A) receiving a backup initiation input from a user;
(B) in response to the backup initiation input, transferring, from a random access memory of a computing device and at least one component in the group consisting of a CMOS of the computing device and a system chipset of the computing device, state information descriptive of a state of the device; and
(C) storing the state information in a hard disk drive of a cradle coupled to the computing device.

101. An apparatus comprising:
means for receiving a backup initiation input from a user;
transference means, responsive to the backup initiation input, for transferring, from a random access memory of a computing device and at least one component in the group consisting of a CMOS of the computing device and a system chipset of the computing device, state information descriptive of a state of the device; and
means for storing the state information in a backup device.

102. A method comprising steps of:
(A) receiving a restore initiation input from a user;
(B) in response to the restore initiation input, transferring, from a backup device to a computing device, state information descriptive of a state of the computing device; and
(C) storing the state information in a random access memory of the device and at least one component in the group consisting of a CMOS of the computing device and a system chipset of the computing device.

103. The method of claim 102, wherein the backup device comprises a cradle, and wherein the computing device is coupled to the cradle.

104. The method of claim 103, wherein the computing device comprises a laptop computer and wherein the cradle comprises a docking station.

105. The method of claim 103, wherein the cradle comprises a hard disk drive, and wherein the step (A) comprises a step of transferring the state information from a hard disk drive of the cradle.

106. The method of claim 102, wherein the computing device comprises a laptop computer.

107. A method comprising steps of:
(A) receiving a restore initiation input from a user;
(B) in response to the restore initiation input, transferring, from a hard disk drive of a cradle to a computing device coupled to the cradle, state information descriptive of a state of the computing device; and
(C) storing the state information in a random access memory of the computing device and at least one component in the group consisting of a CMOS of the computing device and a system chipset of the computing device.

108. An apparatus comprising:
means for receiving a restore initiation input from a user;
transference means, responsive to the restore initiation input, for transferring, from a backup device to a computing device, state information descriptive of a state of the computing device; and
means for storing the state information in a random access memory of the device and at least one component in the group consisting of a CMOS of the computing device and a system chipset of the computing device.
